(19) United States
(12) Patent Application Publication
(10) Pub. No.: US 2010/0096366 A1
(43) Pub. Date: Apr. 22, 2010

(54) FLEXIBLE PROTECTIVE GAS COVER

(75) Inventors: Klaus-Gisbert SCHMITT, Giessen (DE); Wolfgang DOKUPIL, Wieseck (DE); Lothar GERLACH, Wettenberg (DE); Michael SCHNEIDER, Lahnau (DE)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/621,171

(22) Filed: Nov. 18, 2009

(30) Foreign Application Priority Data
May 18, 2007 (DE) DE 202007007226.0
May 14, 2008 (US) PCT/US2008/063594

(51) Int. Cl. B23K 9/16

(52) U.S. Cl. 219/74

(57) ABSTRACT

A joining device for joining a component to a workpiece. The device includes a component holder which moves the component along an axis in a first direction towards the workpiece in order to connect the component to the workpiece, and has a protective gas feed in order to carry out a welding process in a protective gas atmosphere. During the welding process the protective gas is discharged essentially in a second direction which is opposed to the first direction. An elastic sealing sleeve including folding bellows is arranged in relation to the component holder in such a way that a welding space, which is bounded by the workpiece, the component holder, the component and the sealing sleeve and through which the protective gas flows, is sealed off from the external surroundings during the welding process so that the protective gas can escape only in the second direction.

### CROSS-REFERENCE TO RELATED APPLICATIONS

This application claims the benefit of PCT Application No. PCT/US2008/063594, filed May 14, 2008 and German Application No. 10 2007 007 226.0 filed May 18, 2007, the disclosure of which is incorporated herein by reference.

### BACKGROUND OF THE INVENTION

The present invention relates to a device for joining, in particular arc welding, a first component to a second component, in which the welding process takes place in a protective gas atmosphere. The invention is used in particular for stud welding. In stud welding, studs, which are provided, for example, with a thread, are joined or welded to a workpiece, such as for example a vehicle body panel. A significant field of application is in the car industry where various components are connected to one another, for example vehicle body parts are connected to the chassis, etc., by means of studs which are provided with a thread.

“Stud welding” is a form of arc welding which is defined, inter alia, by the fact that very short welding processes are carried out with strong currents. During stud welding it is necessary to coordinate electric switching processes with mechanical movements of the stud in order to be able to handle the very rapid melting and solidification processes.

During stud welding various resources are used to improve the welding process and the result. The use of a protective gas is one of the resources.

Depending on the direction in which the protective gas flows during a welding process, a distinction is made between protective gas welding with a flow of protective gas towards the front, protective gas welding with a flow of protective gas towards the rear or protective gas welding with a flow of protective gas towards the front and flow of protective gas towards the rear. The present invention relates to protective gas welding with a flow of protective gas towards the rear.

In the case of protective gas welding with a flow of protective gas towards the front the welding tool is closed at the rear and open at the front. The terms “rear” and “front” refer to the relative arrangement of the elements: workpiece, studs and welding tool (for example welding head, welding gun etc.). The stud is arranged at the front with respect to the welding device and is moved towards the front in the direction of the workpiece. Of course, the terms “towards the front” and “towards the rear” are not to be understood as restrictive and in practice it is not significant how a welding axis is oriented in relative terms in space, with the workpiece, the stud or the welding tool being located on the welding axis.

Welding devices in which the flow of protective gas (discharge) is towards the rear, i.e. when the welding tool is closed towards the front and open towards the rear (during the welding), are described generally in German Patent Application DE 28 18 896 and German utility model DE 20 2004 001 667 U1.

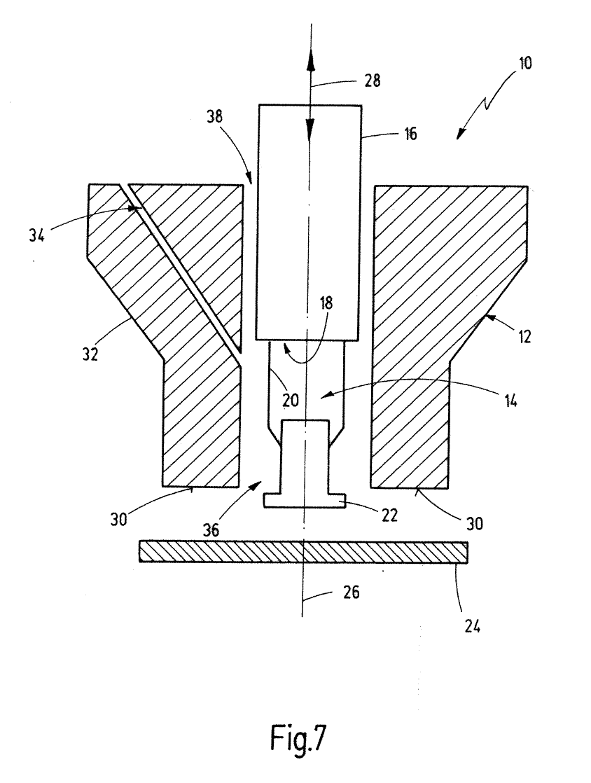

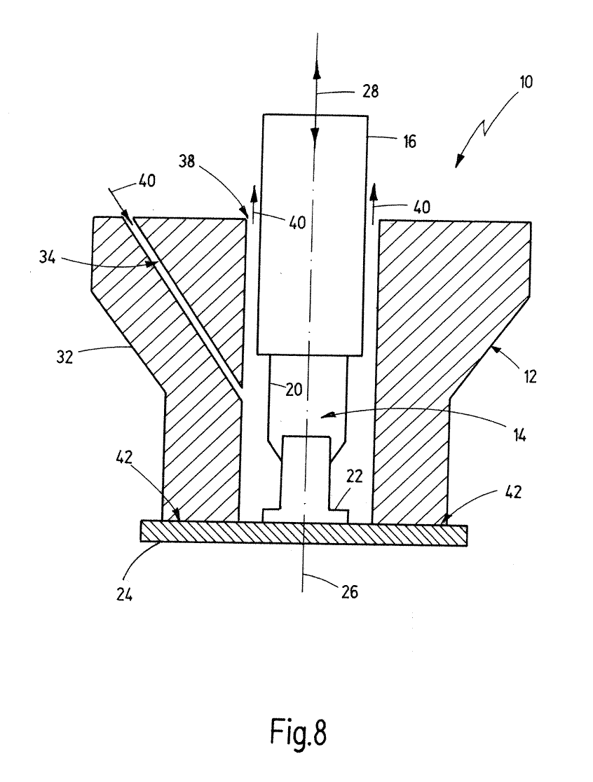

FIGS. 7 and 8 show a related art welding device 10 according to DE 20 2004 001 667 in a neutral position (FIG. 7) and in a welding position (FIG. 8).

Protective gas welding with a flow of protective gas which is directed towards the rear will be explained below with reference to the related art welding device 10 which is illustrated in FIG. 7. The known volume device 10 comprises a cylindrical mouthpiece 12 which tapers towards the front and defines an internal space or cavity 14 in its interior. In the internal space 14 of the mouthpiece 12 a movement device 16 (for example a welding head) is guided. The movement device 16 has, at its front end 18, a stud holder 20 which holds a stud 22 between its arms and is to be joined or welded to a workpiece 24. For this purpose, the welding device 10 is moved towards the front along a (welding) axis 26 in the direction of the workpiece 24. After the welding process has taken place, the welding device 10 is moved towards the rear. This to and fro movement is indicated by means of a double arrow 28. The mouthpiece 12 has (front) contact faces 30 which serve as a stop against the workpiece 24. A body 32 of the workpiece 12 also has a gas feed 34 in order to feed protective gas into an internal space (welding space) 14.

Of course, the location of the protective gas feed 34 in FIG. 7 is illustrated merely by way of example. The protective gas feed 34 could be composed of a plurality of ducts which open into the internal space 14 at a wide variety of locations. For example, the protective gas feed 34 is arranged in such a way that its opening is as far as possible towards the front (relative to the workpiece 24).

The internal space 14 also has a first (front) opening 36 and a second ear) opening 38.

In FIG. 8, the related art welding device 10 in FIG. 7 is shown in a welding position. For this purpose, the mouthpiece 12 was fitted onto the workpiece 24.

Protective gas is then introduced into the internal space 14 via the gas feed 34. The protective gas can leave the internal space 14 towards the “rear” via the second opening 38. The protective gas flow is indicated in FIG. 8 by a plurality of arrows 40. The protective gas ideally only escapes towards the rear. This is the case if the contact surfaces 32 (cf. FIG. 7) adjoin the workpiece 24 in a seal-forming fashion (cf. FIG. 8). This ideal state is indicated in FIG. 8 by arrows 42. During a welding process, the welding space 14 is continuously rinsed with protective gas.

If the mouthpiece 12 does not fit onto the workpiece 24 in a seal-forming fashion, protective gas can escape in the lateral direction (towards the front) or air from the external surroundings can penetrate the internal space 14. This in turn results in eddying occurring with the internal space 14, which has a disadvantageous effect on the quality of the welded connection to be produced. Ideally, a laminar flow of protective gas is generated in the internal space 14, in which case in a joint zone, i.e. the location at which the stud 22 is welded to the workpiece 24, the flow of protective gas should run parallel to the component and otherwise parallel to the stud.

Oblique positions of the welding tool 10 with respect to the workpiece 24 are problematic. Oblique positions may occur if the component is itself curved or the stud 22 is to be welded in the vicinity of edges. Oblique positions open the front protective gas cover and ensure eddying in the joint region. A flow of gas which is directed radially onto the joint zone (air flow) constricts the arc and generates a Venturi effect even when the cover is only slightly opened.

In addition, a large quantity of protective gas is conventionally required for welding (8-15 l/min) in order to protect the joint region against undesired effects from draughts.

It is therefore an aspect of exemplary embodiments of the present invention to provide a welding device which ensures a good welding quality under all conditions. In particular, it is an aspect of exemplary embodiments to allow low protective gas capacities (for example 3 l/min). Another aspect of exemplary embodiments is that unevenesses in the component will preferably not have any effect on the welding quality.

### SUMMARY OF THE INVENTION

According to one aspect, there is a device for joining, in particular are welding, a component, preferably a stud, to a workpiece, wherein the device has a stud holder with which the held stud is moved along an axis in a first direction towards the workpiece in order to connect the stud to the workpiece, and has a protective gas feed in order to carry out the welding process in a protective gas atmosphere, wherein during the welding process the protective gas is discharged in a second direction which is essentially opposed to the first direction, wherein in addition a sealing sleeve is provided which is embodied in the manner of a folding bellows and which is arranged in relation to the stud holder in such a way that a welding space, which is bounded by the workpiece, the stud holder, the stud and the sealing sleeve and through which the protective gas flows, is sealed off from the external surroundings during the welding process so that the protective gas can escape only in the second direction.

The device may include flexible sealing sleeve around the joint zone ensures that protective gas does not leave the joint zone towards the front and ambient air does not enter the welding space from the front. The welding space is (air)tight. Unevennesses on the component or workpiece to which the stud is to be attached can be compensated without problems. Since it is ensured at all times that the welding space is sealed, it is possible to operate with relatively low volume flows of protective gas. The risk of protective gas escaping is greatly reduced. Although a small amount of protective gas (for example only 3 l/min) is used, laboratory trials have shown that the quality of the welded connection between the component and the workpiece is considerably improved. As a result, fewer rejects are produced. Welding systems which use the welding device according to the present invention can be operated with an increased throughput rate.

According to one particular embodiment, the device also has a mouthpiece which can be used as a support foot and which has a body which defines an internal space which has a first opening, which faces the workpiece, and a second opening, wherein the stud holder is arranged in the internal space in such a way that the held stud is located in a front region of the mouthpiece, and at the same e the second opening is arranged in a rear region of the mouthpiece.

Using a mouthpiece reduces the wear on the sealing sleeve. Spatter, which can arise during the welding process, strikes the mouthpiece which is manufactured from a material which is resistant to spatter. The sealing sleeve, which is more sensitive than this material because it is of elastic design, serves then merely to ensure that the welding space is sealed. This lengthens the service life.

According to one exemplary embodiment, the sealing sleeve is attached to the mouthpiece in such a way that in a neutral position of the device with respect to the mouthpiece the sealing sleeve protrudes in a non-stressed state, and in a welding position of the device said sealing sleeve bears against the workpiece in a stressed state.

When the folding-bellows-like sealing sleeve is fitted onto the workpiece it is compressed or pressed together. If the workpiece moves away, for example, from the sealing sleeve, at the location at which the sealing sleeve is in contact with the workpiece (the welding tool slips for example), the stress on the sealing sleeve is automatically released, i.e. the sealing sleeve itself ensures that it remains in contact with the workpiece and continues to seal the welding space.

In addition, the elasticity of the sealing sleeve ensures that even studs which have a topography with pronounced differences in height can be welded onto workpieces.

In particular, the sealing sleeve is attached to a contact surface or an external bush of the mouthpiece in a front region of the mouthpiece. The further forward the sealing sleeve is seated, the smaller the amount of material which is necessary to manufacture it.

Furthermore, it is advantageous if a first surface, which is surrounded by the sealing sleeve when the sealing sleeve is in contact with the workpiece, is larger than a second surface which corresponds to a projection of the first opening onto the workpiece.

The sealing sleeve therefore always securely surrounds the mouthpiece or its opening, which is arranged opposite the workpiece. In this way it is possible, for example, even to weld studs with very small radii (r≈10 mm), such as for example M8 aluminium studs, to the component in a gas-tight fashion. The welding process can be reproduced even with very small radii.

According to a further preferred embodiment, the device also has a mask with at least one opening, wherein each opening is coupled to a sealing sleeve.

A mask which is embodied in this way can be used as a type of template in order to weld a plurality of studs onto one component. To do this, an operator simply has to introduce, for example, a welding gun into the opening of the mask and can then weld the stud in a gas-tight fashion. A mask also increases the working speed since the welding location is predefined for the operator by the openings in the mask.

Each opening is preferably lined with a bush to which the sealing sleeve is attached.

This makes it possible to replace a defective sealing sleeve easily and quickly since the sealing sleeve is not connected directly to the mask but rather to a ring or the like so that it can be replaced quickly.

In particular, the rubber sleeve is embodied in one part and preferably rotationally symmetrically.

This facilitates the manufacture of said rubber sleeve.

Furthermore, it is advantageous if the sealing sleeve is formed from a plurality of parts which are mounted so as to be movable with respect to one another in order to permit the sealing sleeve to open laterally.

This embodiment of the sealing sleeve is provided in particular for welding devices whose stud holders consist of grippers which are equipped with rigid gripping fingers which can be displaced laterally.

In this case the parts of the multi-component sealing sleeve may have male and/or female coupling elements at their ends.

These coupling elements ensure that in a closed state of the sealing sleeve the welding space is sealed.

The sealing sleeve may have a contact-forming edge which ensures that contact is formed with the workpiece over an area.

A seal may be produced over an area compared to a linear seal since it is then also possible to compensate better for unevenesses in the radial direction.

Of course, the features which are mentioned above and will be explained below can be used not only in the respectively specified combination but also in other combinations or in isolation without departing from the scope of the present invention.

### DETAILED DESCRIPTION OF EXEMPLARY EMBODIMENTS OF THE INVENTION

Exemplary embodiments of the invention are illustrated in the drawing and will be explained in more detail in the following description. In said drawing;

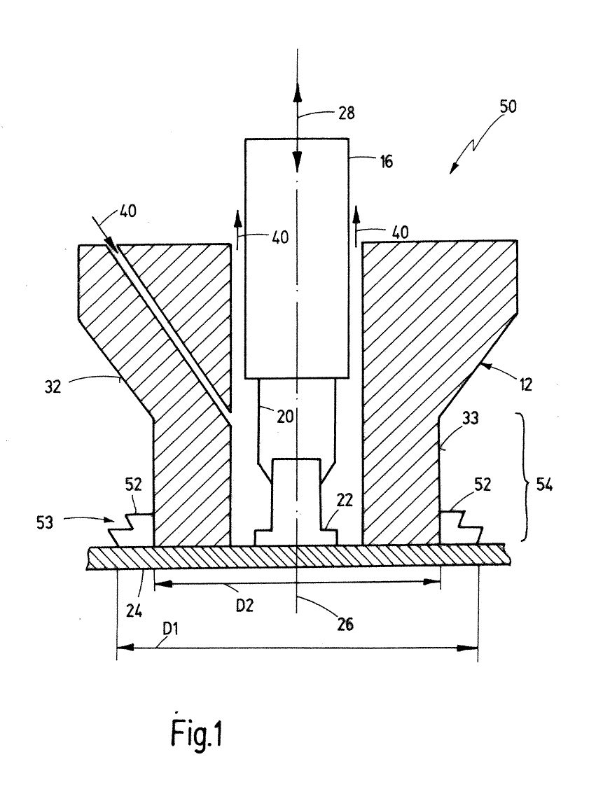

FIG. 1 shows a sectional side view of a first exemplary embodiment of the present invention in a welding position;

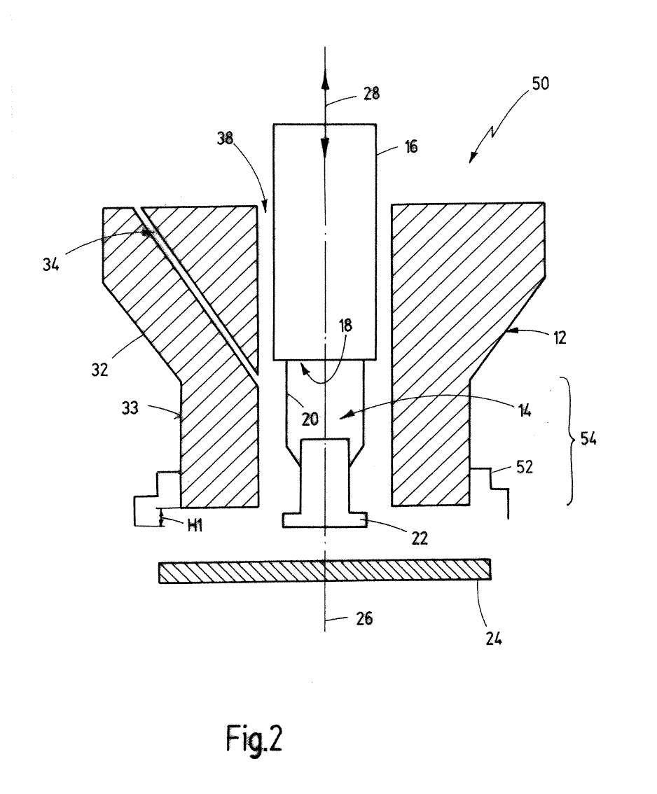

FIG. 2 shows the welding device from FIG. 1 in a neutral position;

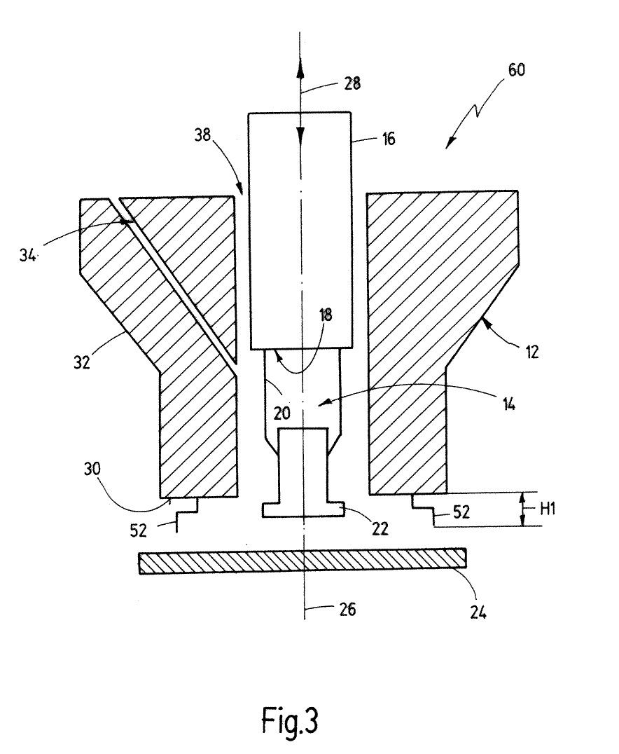

FIG. 3 shows a second exemplary embodiment of a welding device according to the present invention in a neutral position;

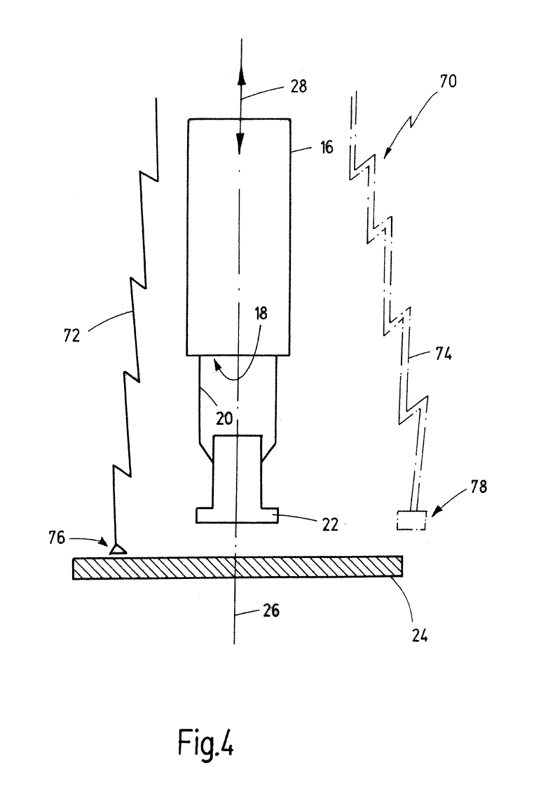

FIG. 4 shows a third exemplary embodiment of a welding device according to the present invention in a neutral position;

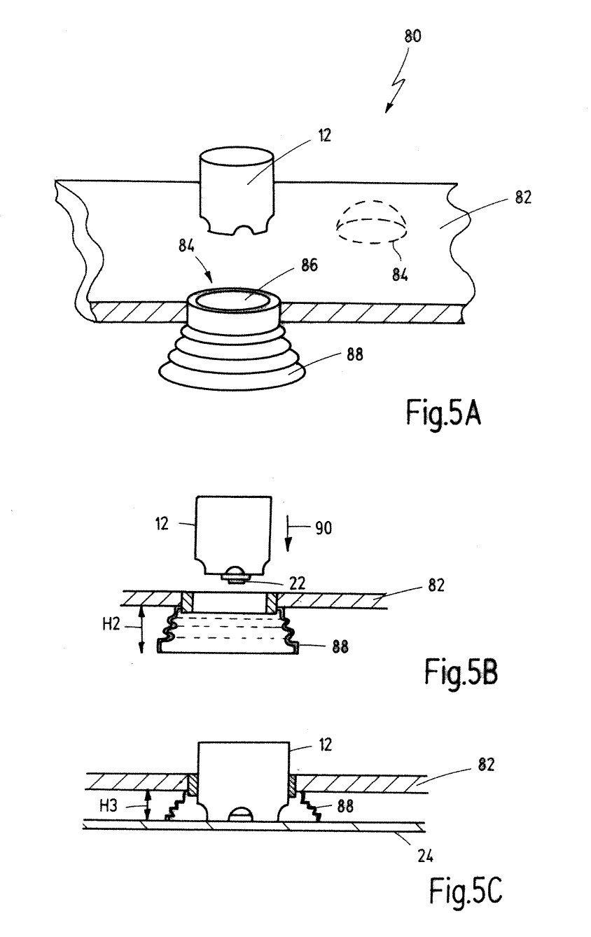

FIG. 5a-5c shows a further exemplary embodiment of the present invention;

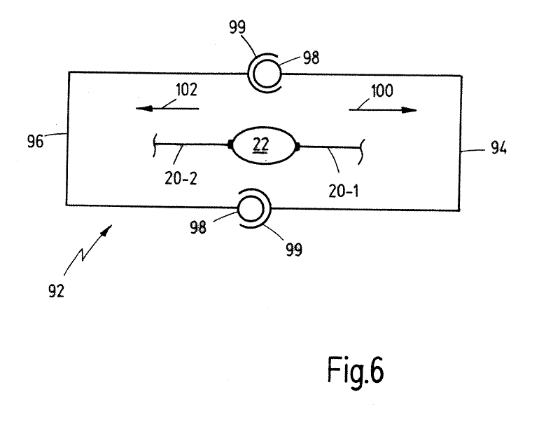

FIG. 6 shows a cross section through a sealing sleeve according to the present invention;

FIG. 7 shows a related art welding device in a neutral position; and

FIG. 8 shows the welding device from FIG. 7 in a welding position.

In the following description of exemplary embodiments of the present invention, identical components are provided with the same reference symbols.

FIG. 1 illustrates a first exemplary embodiment of a welding device 50.

The welding device 50 is constructed like the welding device 10 in FIGS. 7 and 8, with an elastic sealing sleeve 52 being additionally provided in a front region 54 of the mouthpiece 12. The sealing sleeve 52 is attached to an external sleeve 33 of the mouthpiece body 32.

In the example in FIG. 1, the sealing sleeve 52 is embodied so as to be rotationally symmetrical with respect to the welding axis 26 and thus has here an essentially circular cross section (in plan view). The cross section which is illustrated from the side in FIG. 1 shows a folding-bellows-like design. The sealing sleeve 52 in FIG. 1 merely has one fold 53 running in the circumferential direction of the mouthpiece 12. Of course, any desired number of folds 53 could be provided. The term “folding bellows” is to be understood as encompassing any structure which tapers towards the rear and which permits the sealing sleeve 52 to be compressed in the direction of the axis 26.

The sealing sleeve 52 is of elastic design. It is preferably composed of rubber or silicone (for example UL listed). Since the sealing sleeve 52 may be subject to weld spatter, a material is selected which is very largely resistant to such spatter but which ensures elasticity.

The sealing sleeve 52 preferably has a wall thickness of <1 mm.

The sealing sleeve 52 is compressed in the direction 26 in the welding position of the mouthpiece 12 in FIG. 1. It completely surrounds the mouthpiece 12 which has a diameter D2. One edge of the sealing sleeve 52, which is connected to the workpiece 24, therefore has a relatively large radius D2.

FIG. 2 illustrates a neutral position of the welding device 50 in FIG. 1.

The sealing sleeve 52 is shown in a non-stressed state. In the non-stressed state the sealing sleeve protrudes with respect to the mouthpiece 12, as is indicated by a height difference H1.

If the mouthpiece 12 is placed on the workpiece 24 (cf. FIG. 1) in order to carry out a welding process, the sleeve 52 is compressed and thus independently ensures that its edge remains stuck to the workpiece 24. Even if the mouthpiece 12 is fitted onto the workpiece 24 in a misaligned fashion, the sealing sleeve 52 ensures that air from outside the mouthpiece 12 cannot enter the internal space or welding space 14 through a gap which is produced in the front region or at the front opening as a result of the misalignment.

As soon as the mouthpiece 12 has fitted onto the workpiece 24, protective gas is fed in via the feed 34 and rinsed until it is ensured that the entirety of the internal space 14, and if misalignment occurs, also the space which is bounded by the sealing sleeve 52 (space between the mouthpiece 12 and sealing sleeve 52), is filled with protective gas. The protective gas then flows through the mouthpiece 12 and leaves it through the rear opening 38.

FIG. 3 shows another exemplary embodiment of a welding device 60 according to the present invention. The welding device 60 differs from the welding device 50 in FIGS. 1 and 2 in that the sealing sleeve 52 is arranged on the contact-forming surface 30 instead of the external sleeve 33 of the mouthpiece 12.

As is illustrated in FIG. 4, the mouthpiece 12 is not absolutely necessary to be able to carry out a welding process in a protective gas atmosphere.

By contrast with the welding devices in FIGS. 1 to 3, the welding device 70 according to the exemplary embodiment illustrated in FIG. 4 does not have a mouthpiece 12. Instead, the protective sleeve is made correspondingly larger. The protective sleeve in FIG. 4, two embodiments 72 and 74 of which are shown here, is large enough that the welding head 16, the stud holder 20 and the stud 22 are surrounded completely by the sleeve.

The protective sleeve 72 is embodied with one wall and is illustrated in the left-hand part of the figure. A double-walled refinement 74 is illustrated in the right-hand part with a dot-dash line.

One end 76 of the sealing sleeve 72 is illustrated with a three-cornered cross section, while one end 78 of the sealing sleeve 74 is illustrated with a rectangular cross section. These cross-sectional shapes have been selected by way of example in order to illustrate a seal over an area between the sealing sleeve and workpiece 24. Without ends which are embodied in such a way, a linear seal is obtained, which is however also possible. A seal over an area (in the radial direction with respect to the axis 26) also ensures, however, that unevenesses on the workpiece 24 in the radial direction can be compensated for.

FIG. 5a shows a perspective view of a further embodiment of the present invention.

FIG. 5a shows a welding mask 82 with one or more openings 84. The opening 84 has here an internal bush 86 which is in turn connected to a sealing sleeve 88. However, the sealing sleeve 88 could, of course, also be connected directly to the opening 84. The connection to the bush 86 permits easier replacement of a defective sealing sleeve 88.

Welding masks 82 are used, for example, if the welding process is carried out manually, for example with a welding gun (not illustrated). The operator (not illustrated) must then simply introduce the welding gun into the opening 84 and weld. The rest of the welding process then takes place automatically, specifically in a gas-tight fashion in a protective gas atmosphere.

FIG. 5b shows a sectional side view of FIG. 5a.

FIG. 5b clearly shows that the height H2 of the sealing folding bellows 88 is significantly larger than its height H3 in FIG. 5c.

FIG. 5b illustrates a state in which a welding gun is introduced with a mouthpiece 12 in the direction of an arrow 90 into the opening 84. The welding mask 82 could for this purpose be folded down, for example, with a hinge from a (vertical) position of rest into a (horizontal) working position. A working position is shown by way of example in FIG. 5c.

In FIG. 5c the sealing sleeve 88 is compressed. This ensures that the welding process takes place in a gas-tight fashion. The height H3 corresponds virtually to the distance between the workpiece 24 and the mask 82. In FIG. 5c, the mouthpiece 12 is introduced into the opening 84. In this state in FIG. 5c, the welding process can be carried in a gas-tight fashion.

FIG. 6 shows a cross section through a further embodiment of a sealing sleeve 92 in a plan view.

The sealing sleeve 92 is constructed from a plurality of parts, in this case of two parts 94 and 96. It has, by way of example, a rectangular cross section.

The sealing sleeve 92 surrounds a stud holder with partially illustrated grippers 20-1 and 20-2. The grippers 20-1 and 20-2 hold the stud 22 between them and have to be moved in the direction of the arrows 100 and 102 in order to load a new stud 22. This is the reason why the sealing sleeve 92 is in fact constructed from two parts, in order to be able to follow the movement of the grippers 20-1 and 20-2.

The sealing sleeve parts 94 and 96 have coupling elements at their respective ends. Male coupling elements are designated by 98. Female coupling elements are designated by 99.

Of course, the sealing sleeve could also be constructed from more than two parts or else also be constructed in only one part, depending on the field of application. The shape of the cross section can also be varied.

The welding device according to the present invention is defined by its high degree of resistance to oblique positioning of the welding tool in relation to the workpiece or unevenesses in the workpiece. Less protective gas is used. The quality of the gas cover is so good that spatters are reduced to an excellent degree and constantly reproducible welding results are thus obtained. Rubber sleeves have a long service life. It is, for example, also possible to weld M8 studs made of aluminium. The rubber sleeve preferably has a degree of hardness of <80 Shore. The folding bellows according to the invention generates a pressing force on the component itself by virtue of the fact that it is of elastic design and protrudes, for example, with respect to the mouthpiece.

It will be appreciated by persons skilled in the art that the above embodiments have been described by way of example only, and not in any limitative sense, and that various alterations and modifications are possible without departure from the scope of the invention as defined by the appended claims.

1. A joining device for joining a component to a workpiece, comprising:
a component holder with which the component is moved along an axis in a first direction towards the workpiece in order to connect the component to the workpiece, and has a protective gas feed in order to carry out a welding process in a protective gas atmosphere, wherein during the welding process the protective gas is discharged essentially in a second direction which is opposed to the first direction, wherein an elastic sealing sleeve including folding bellows is arranged in relation to the component holder in such a way that a welding space, which is bounded by the workpiece, the component holder, the component and the sealing sleeve and through which the protective gas flows, is sealed off from the external surroundings during the welding process so that the protective gas can escape only in the second direction.

2. The joining device according to claim 1, further comprising a mouthpiece which can be used as a support foot and which has a body which defines an internal space which has a first opening, which faces the workpiece, and a second opening, wherein the component holder is arranged in the internal space in such a way that the held component is located in a front region of the mouthpiece, and wherein the second opening is arranged in a rear region of the mouthpiece.

3. The joining device according to claim 2, wherein the sealing sleeve is attached to the mouthpiece in such a way that in a neutral position of the device with respect to the mouthpiece the sealing sleeve protrudes in a non-stressed state, and in a welding position of the device said sealing sleeve bears against the workpiece in a stressed state.

4. The joining device according to claim 3, wherein the sealing sleeve is attached to a contact surface or an external bush of the mouthpiece in a front region of the mouthpiece.

5. The joining device according to claim 4, wherein a first surface, which is surrounded by the sealing sleeve when the sealing sleeve is in contact with the workpiece, is larger than a second surface which corresponds to a projection of the first opening onto the workpiece.

6. The joining device according to claim 1, which also has a mask with at least one opening, wherein each opening is coupled to a sealing sleeve.

7. The joining device according to claim 6, wherein each opening is lined with a bush to which the sealing sleeve is attached.

8. The joining device according to one of the preceding claims, wherein the rubber sleeve is a single unitary part and is rotationally symmetric.

9. The joining device according to claim 1, wherein the sealing sleeve is formed from a plurality of parts which are mounted so as to be movable with respect to one another in order to permit the sealing sleeve to open laterally.

10. The joining device according to claim 9, wherein the parts forming the sealing sleeve include at least one of male and female coupling elements at their ends so that, in a closed state of the sealing sleeve, they close in a seal-forming fashion with their respective adjacent parts.

11. The joining device according to claim 10, wherein the sealing sleeve has a contact-forming edge which ensures that contact is formed with the workpiece over an area.

12. The joining device of claim 1, wherein the component is a stud and the component holder is a stud holder.

13. The joining device of claim 1, wherein the component is a stud and the component holder is a stud holder; and
wherein the joining device joins the stud to the workpiece through arc welding.

14. A joining device for joining a component and a workpiece, comprising:
a component holder configured to hold a component;
a movement device which moves the component holder if a first direction towards the workpiece;
an elastic sealing sleeve which surrounds the component held by the component holder, the elastic sealing sleeve being compressible and having an end configured to contact the component.

15. The joining device of claim 14, further comprising a mouthpiece which surrounds the component; and
an elastic sealing sleeve extending from the elastic sleeve past a front surface of the external sleeve.

16. The joining device of claim 15, wherein the elastic sealing sleeve is compressible such that an end of the elastic sealing sleeve can be compressed such that it is level with the front surface of the external sleeve.

17. The joining device of claim 16, wherein the external sleeve is part of a mouthpiece which includes a gas feed which supplies gas.

18. The joining device of claim 17, wherein the elastic sealing sleeve creates a welding space which is bounded by the workpiece, the stud holder the stud and the sealing sleeve such that during a welding process carried out by the joining device, gas supplied by the gas feed is sealed off from external surroundings and is forced to travel in a second direction, opposite the first direction.
